(19) United States
(12) Patent Application Publication
(10) Pub. No.: US 2004/0052336 A1
(43) Pub. Date: Mar. 18, 2004

(54) Method for managing use of a telecommunication line and system therefor

(76) Inventors: Partick Langlet, Cambes en Plaine (FR); Wilfrid Rabot, Cresserons (FR); Jean-Luc Olivier, Authic (FR); Patrick Picard, allee du valrenouf (FR)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 10/380,683

(22) PCT Filed: Sep. 13, 2001
(86) PCT No.: PCT/FR01/02838

(30) Foreign Application Priority Data
Sep. 15, 2000 (FR) 0011772

(51) Int. Cl. H04M 1/24

(52) U.S. Cl. 379/1.01

(57) ABSTRACT

The invention concerns a method for managing the use of a telecommunication line and/or terminal connected thereto. The invention is characterised in that it consists in controlling the use of the line for any access to a broadband service, operated on said line so as to: control the setting up of said line for each access request for a broadband service (for example ADSL), measure the duration of occupancy of said line for each of said accesses, control the cutting of said line at the end of each of said accesses or on detecting a fraud. The invention is applicable to a public telephone system and in particular to Internet terminals for public use.

The invention relates to a method for the management and use of a telecommunication line and/or a terminal. It also relates to a system for using this method.

The invention is more particularly applicable to telecommunication lines for customer installations enabling broadband accesses also qualified as high-speed accesses. Throughout the rest of this description, we will also refer to the terms “broadband” or “high speed ” services indifferently. It is particularly applicable to publiphones, and particularly to Internet terminals provided to the public.

Many customer installations connected to narrow band services (access to the switched telephone network STN) or the analogue or ISDN digital network, also enable accesses to broadband services (xDSL or Home PNA).

Remember that customer installations are Customer Premises Networks (CPN).

They begin at the Network Interface Demarcation (NID) at home, and comprise all cables, copper pairs and telephone connectors. It is connected (possibly through active equipment such as a PABX) to an access network to narrow band services and broadband services. In practice, it is a telephone and remote computer installation connected to the telephone network comprising one or several narrow band terminals such as telephones, faxes, answering machines, modems or any type of analogue or digital (ISDN) equipment, and one or several broadband terminals based on the DSL or Home PNA technology.

A broadband service is any service transmitted in a spectral band higher than narrow band services (i.e. telephony or ISDN), i.e. at frequencies higher than 10 kHz. Typically, they will be services provided through the xDSL network, or for example based on purely private Home PNA systems. Home PNA is a Consortium created in 1998 in order to federate specifications for transmission systems on telephone pairs (Home Phoneline Networking Alliance).

We will use the term xDSL to refer to broadband services including all technological families such as SDSL, ADSL, ADSL-lite, VDSL.

Until now, the use of telecommunication lines or broadband terminals connected to the said lines for accesses to broadband services has been based on a subscription. Thus, the line is set up after the subscription has been taken out and it is cut off after the subscription has been cancelled. Billing is done by subscription, regardless of the occupancy time of the line for accesses to broadband services.

At the moment there is a need to provide the public with telecommunication terminals (available in public areas) providing access to Internet. This need raises the problem of billing as a function of use for each user of these terminals and in general the problem of controlling the use of lines and terminals. It is quite obvious that there is no solution to this problem at the present time.

This invention is designed to solve this problem.

This invention is used to control use of telecommunication lines for access to broadband services and in particular will enable billing based on the occupancy duration.

The main purpose of this invention is more specifically a method for managing the use of a telecommunication line and/or a terminal connected to it, mainly characterised in that it comprises the following steps:

control use of the line for any access to a broadband service operated on this line, in order to:

set up the said line for each access request to a broadband service (for example ADSL),

measure the occupancy time of this line for each of the accesses,

control cut off of the said line when each of the said accesses stops or on detection of a fraud.

According to another characteristic, control of the use of the line may be made on a frequency band separate from the frequency band for the broadband service.

According to another characteristic, control of the use of the line may be made on the same frequency band as the frequency band for the broadband service.

According to another characteristic, the line is set up and interrupted for accesses to broadband services for the said line.

According to another characteristic, the control includes the control of payment for use of this line during an occupancy time measured during an access.

The control includes also a check of the charge.

The control also checks operation of the terminal(s) connected to the line.

The control may also include downloading of application programs onto these terminals.

The invention also relates to a method for managing the use of at least one telecommunication line and/or at least one terminal connected to it, characterised in that it comprises:

means of controlling setting up and interrupting the line for setting up the line following each request for access to a broadband service (for example ADSL), and interrupting the line at each access stoppage, or on detection of a fraud;

means of measuring the occupancy time of the line during the said access.

According to another characteristic, control means comprise means of checking operation of the customer installation terminal(s).

According to another characteristic, the method comprises means of connection with the customer installation to which the telecommunication line and/or the terminal is assigned.

According to another characteristic, connection means between the control means and the terminal(s) may include low speed lines (STN or ISDN).

According to another characteristic, connecting means between the control means and the terminal(s) may include high-speed lines (ADSL, for example).

According to another characteristic, the method comprises a connection interface (DSLAM) between at least one broadband service line and the public network.

According to another characteristic, the method comprises means of cutting off and setting up the line.

According to another characteristic, the connection interface comprises means of cutting off and setting up the line and it is placed in the customer installation.

According to another characteristic, the interface (D) is placed in the public network and is controlled from the customer installation.

According to another embodiment, the control means comprise means of cutting off and setting up the line and they are placed in the customer installation.

Other particular features and advantages of this invention will become clear after reading the description given for illustrative purposes and that is in no way limitative with reference to the attached drawings that show:

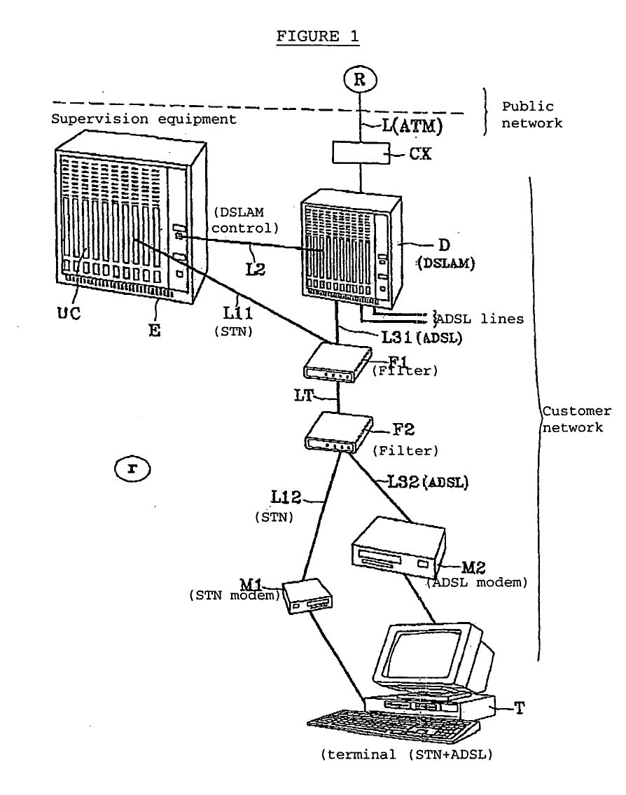

FIG. 1, a management system according to a first embodiment,

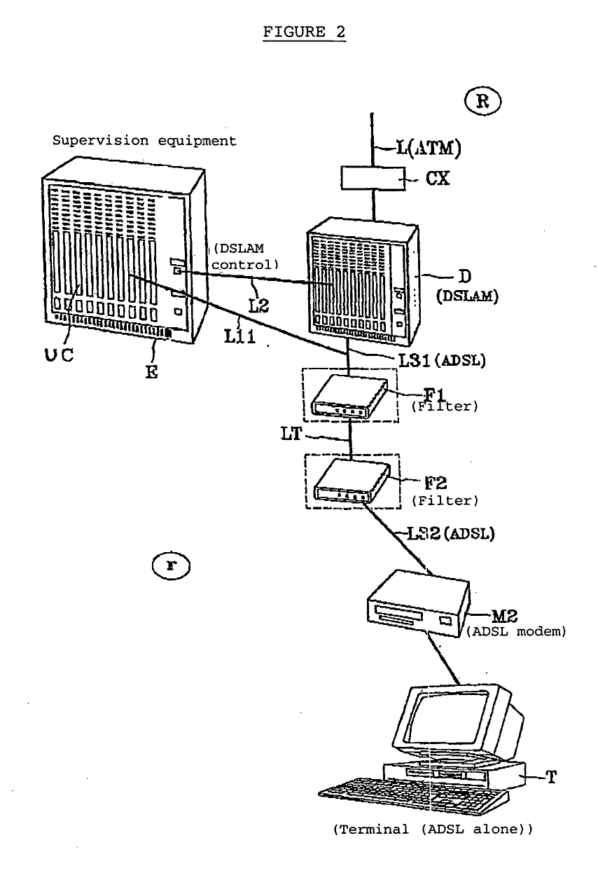

FIG. 2, a variant embodiment of this first embodiment,

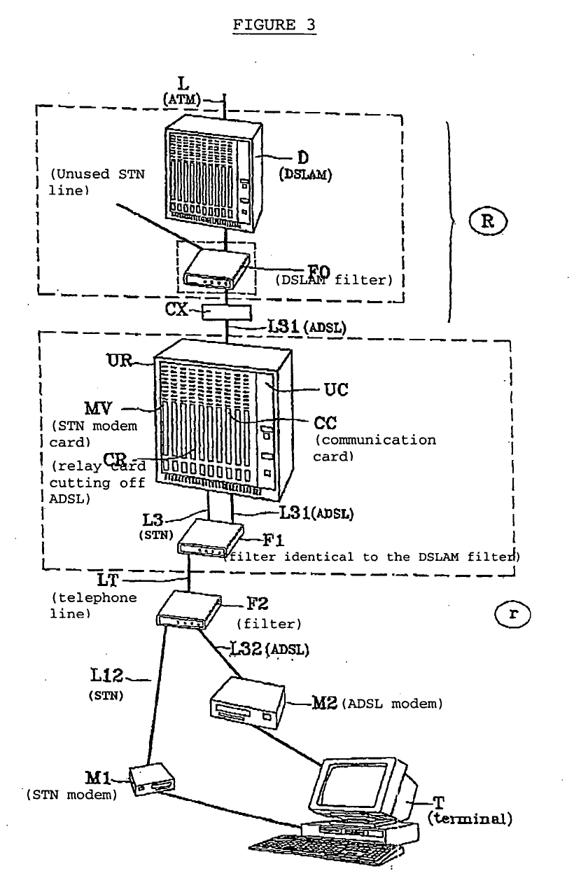

FIG. 3, a management system according to a second embodiment,

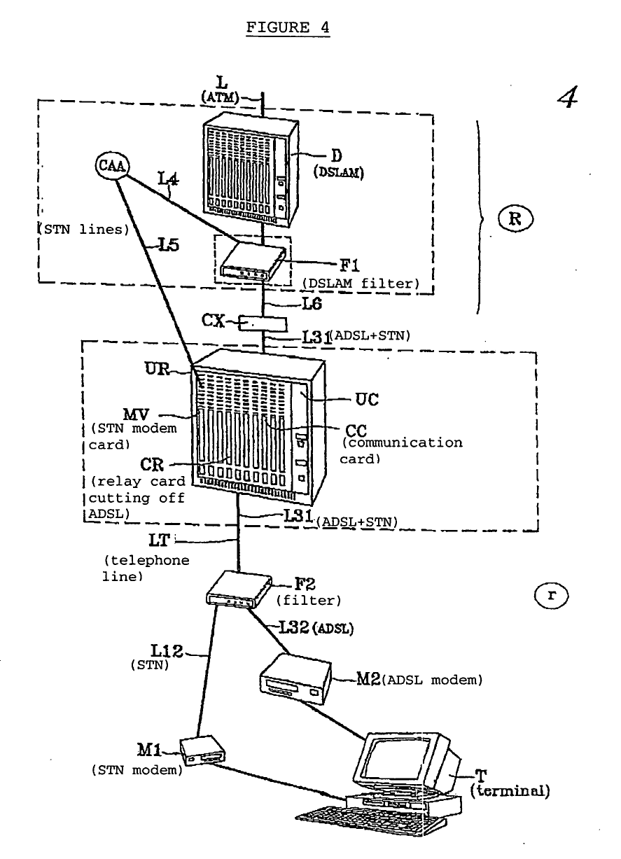

FIGS. 4, 5 and 6 are diagrams of variant embodiments related to the second embodiment.

In the first embodiment shown in FIG. 1, the management system comprises means of cutting off and setting up the LT line when it provides access to broadband services, according to the invention. These means consist of a device D controlled by a control and supervision equipment E.

In the remaining part of this description, we will talk about setting up or cutting off the line when the line is used for broadband accesses. There is no need to cut off this line for all services, namely in particular for narrow band services, particularly because in the embodiments to be described later, it is intended to use the narrow band service for example through the switched telephone network (SDN) lines to control the terminals.

The device D is connected firstly to the public network and secondly to the broadband line in the customer network L31. The connection to the public network is made through a connector CX that connects the device to a high-speed transmission line in the public network R. This transmission line may for example be an asynchronous transmission line ATM. The device D is also connected to the supervision equipment E through a control line L2.

The device D also comprises several connection points to broadband lines, in other words to ADSL type lines in the customer network for which the line L31 is shown in the figure. This line is the output from a filter F1 that separates the bands (narrow band and broadband) on the telecommunication line LT. This filter is connected to another filter F2 through a telecommunication line LT, the filter F2 enabling a separation between the narrow band and the broadband transmitted through this telecommunication line T2, in the network to terminal direction.

Thus, the terminal T is connected through a modem M2, an ADSL modem, to the filter F2 through an ADSL line L32. The terminal T is also connected to the narrow band service, i.e. to the STN network through a modem M1 through a narrow band line L12 connected to the filter F2.

The supervision equipment E supervises the terminals in the customer network R. Therefore, this equipment is designed to control firstly the device for setting up and cutting off the line D and at the same time controlling the terminals, namely controlling the means of payment of these terminals, and supervising the charging, checking the state of the terminals and also downloading application programs into the terminals if necessary.

Advantageously, in order to obtain the function to cut off and set up the line when the line makes a broadband service access, the device used is standard industrial equipment called DSLAM used for its capabilities of cutting off and restoring the connection. Normally, this type of equipment is used and designed to put a subscriber into service and to break his connection when his subscription is cancelled. In this case, the function is used to set up the connection when an access request is made to a broadband service and to cut off this connection each time that the access is terminated.

This device D is also used to measure the line occupancy time during this access. Thus, the equipment E will be able to make a real time check of the occupancy time of the line during the requested and successful broadband accesses, and will control payment corresponding to use of the line during the measured occupancy time.

This device D may be controlled either locally or remotely, such that the equipment E could be remote from terminals while remaining in the customer network r. In all cases, devices such as DSLAMs have interfaces that they can use for local or remote control. For example, interfaces that can be used for these devices include an RS232 local port and an Ethernet port.

The communication protocol between the DSLAM and the control equipment is defined by the manufacturer who made the DSLAM device.

These interfaces offer the possibility of activating and deactivating a channel in the device. The order in which the channel is activated or deactivated is given by the supervision equipment E that receives an access request sent by the terminal T. According to a first embodiment illustrated in FIG. 1, this access request is communicated to the supervision equipment through narrow band lines, namely STN lines L12 and L11.

The communication line LT is connected to the public network and more particularly to a high-speed network (for example ATM) through the standard industrial equipment D called DSLAM.

In the embodiment shown in FIG. 1, this D equipment is private, i.e. it is in the customer network r, the output channel from the said device being connected to the telecommunication line L in the public network R through the conventional connection network CX. In one variant embodiment, this device D could be in the public network R and it could be controlled by the customer network r.

Thus, in the embodiment shown, the device D performs functions to cut off and set up the line LT during each access to broadband process services on this line and measures the occupancy time during these accesses and the connection to the public network R, and is controlled by the control equipment E.

The equipment E is capable of supervising terminals T in the installation and behaves as has been described above: for connections with these terminals. When a terminal T makes an access request to a broadband service, the equipment E controls opening of the “broadband” line LT to the device D, through a line L2. When the terminal T stops its access, the equipment E controls the device D to cut off the “broadband” line LT. The device D is capable of supplying the corresponding occupancy time for the line.

According to the embodiment shown in FIG. 1, the customer network may comprise one or several telecommunication terminals T providing access to narrow band services, i.e. access to the switched telephone network and also accesses to broadband and therefore high-speed services (for example ADSL) through the LT line.

To simplify matters, this figure shows a single telecommunication terminal T. In the case in which the customer network R comprises several terminals T, these terminals will be connected to other telephone lines LT not shown.

In more detail, the equipment E comprises an STN modem connected to the telephone line L11 (STN) that makes the connection between the telecommunication line LT and the equipment E. The telephone line L11 is connected for this purpose to the narrow band output (telephone band) of the band separator filter F1. The broadband output from this band filter is connected through a broadband line L31 (ADSL) to device D.

The equipment E also comprises a control unit UC capable of supplying commands to the device D to limit cutting off or opening the line L31 and the use of functions for supervision of payments, supervision that terminals are functioning correctly, and possibly for downloading application programs. This unit UC will comprise one or several program(s) for running supervision functions for this purpose, namely the use of a procedure for authentication of the terminal user (which is a conventional procedure in itself), for checking the charge applied for the billing calculation that will be made as a function of the measured occupancy time and output by device D. In practice, the data sent through the billing centre will be controlled by equipment E.

In a second variant embodiment illustrated by the scheme in FIG. 2, but which also corresponds to the first embodiment, the terminal(s) is (are) supervised through a high-speed broadband connection. Obviously, in this case, the elements corresponding to the low speed line, namely the modem M1 and the lines L11 and L12, are no longer necessary. The equipment E is directly connected to the access line to the broadband service L31.

Furthermore, the narrow band and broadband separation filters F1, F2 of ADSL services are no longer necessary in the architecture corresponding to this variant embodiment. These filters are shown in dashed lines.

According to the invention, there is also a second embodiment for the management system. This second embodiment is illustrated by the diagram in FIG. 3. In this embodiment, the means for setting up and cutting off the line are placed in the public network that is consequently outside the customer network.

The customer network is connected to the public network through a high-speed connection unit. This unit UR comprises functions for supervision of the customer network terminals, in the same way as equipment E in the first embodiment, and the connection equipment to the public network and the function to set up and cut off the telecommunication line L31.

To achieve this, the connection unit is provided with a system unit UC, a communication unit CC communicating with the public network management system, and a relay CR cutting off the high speed line (ADSL).

The terminal or terminals T is (are) supervised through a low speed communication line (L3) (STN or ISDN telephone line). This is done by providing an MV modem (integrated) into the connection unit UR to make the connection with this line L3. Conventional switched telephone network modems (for example V23 to V90) may be used for supervision, with one M2 being placed on the terminal side and the other MV being placed on the high speed connection unit UR. As mentioned above, in this case, this modem may be integrated in this unit UR.

To enable voice communications in all cases on the STN telephone lines used for supervision of the terminals, it would be possible to transmit supervision signals in infra-voice or supra-voice (or in other words in a band lower than 300 Hz or higher than 3400 Hz, but still less than 10 or 12 kHz).

The high-speed connection unit UR is placed on the output side of the device D within the local switch cutting off the high-speed line (ADSL). The device D is used in this case for its connection function with the high-speed line L (ATM) in the public network.

According to this embodiment illustrated in FIG. 3, the terminals are supervised by the connection unit UR through low speed lines L3 and L12. Therefore, it is necessary to have a band separation filter F1 to filter broadband services and narrow band services, and to separate these bands at the L3 and L31 lines respectively connected to the connection unit.

Other variant embodiments corresponding to this embodiment may be considered. For example, there are the variants corresponding to FIGS. 4, 5 and 6.

Consequently, this variant shown in FIG. 4 always comprises a high-speed connection unit but it does not necessitate any band separation filtering provided by the filter F1 in FIG. 3.

Supervision is done through the switched network CAA. In this case, it is planned that, outside the high speed communication, the connection unit can use a low pass filter LF on the line only allowing low speed signals to pass through to the network R. Obviously, this low pass filter BF may be included in the connection unit UR. The connection unit UR can thus supervise the terminal T when there is no high-speed communication (to control its payment method) without allowing the high-speed communication to pass through. The communication between the MV modem of the connection unit and the M2 modem of the terminal is made using one of the two modems or permanently.

The connection unit UR will invalidate the above-mentioned low pass filter BF, to authorize high-speed communication. In this case, high-speed signals (ADSL or SDN) are transmitted.

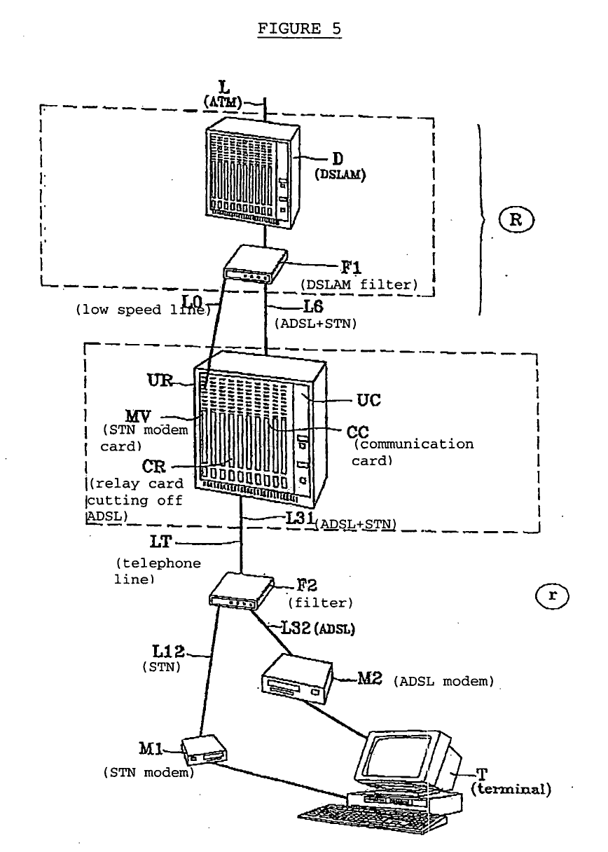

The diagram in FIG. 5 illustrates another variant embodiment of the second embodiment (FIG. 3) according to which the terminal or terminals in the customer network r is (are) supervised directly without going through the switched telephone network CAA, and this is the case in the variant illustrated in FIG. 4.

The output from the filter F1 associated with the device D is sent directly towards the connection unit UR, without passing through the general switched network CAA. The telephone line L0 (pseudo STN), i.e. the low speed line, is permanently set up. This line does not pass through the switched network. A V23 or V90 modem may be used to make this line.

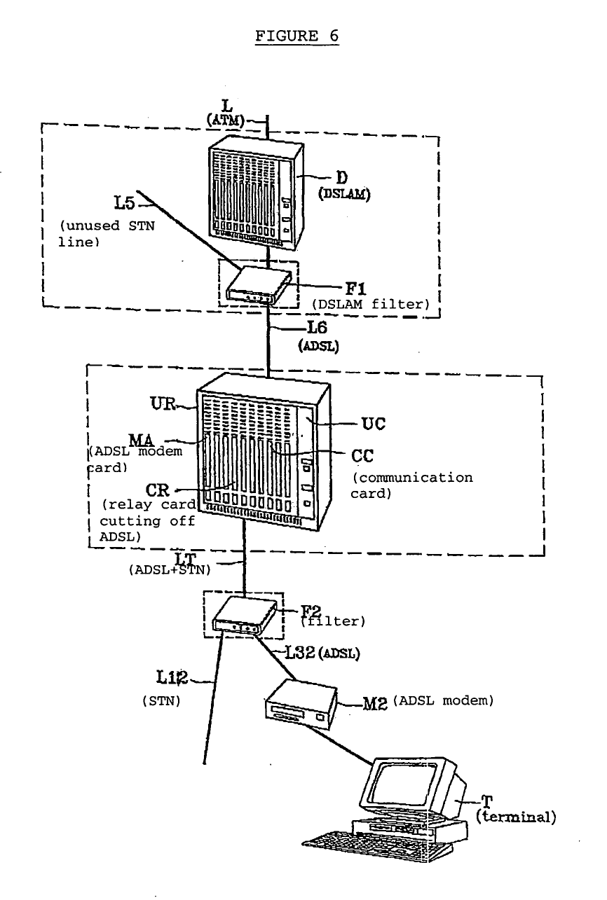

The variant illustrated in FIG. 6 enables supervision through a broadband line (ADSL high speed). This supervision may be done by the ADSL LT line itself. The proposed architecture is then like that shown in FIG. 6. The telephone line L5 (STN) is unused. The band separator filters F1 and F2 are then pointless. This is why they-have been shown as dashed lines.

The condition for using this architecture is that it is possible to superpose supervision of this communication on the high-speed line. This is done by direct dialogue between the high-speed modems located between the connection unit UR and connected to the terminal. A dialogue can then be set up between the terminal and the high-speed connection unit.

In practice, one high-speed modem MA will be integrated into the unit UR and the other modem M2 will be connected to the broadband output of the terminal.

However, this dialogue must not be transmitted to the device D. Therefore the connection unit must filter the dialogue and it must not transmit it to the device D.

Filtering may be done by software. The solution can then consists of using an IP (Internet Protocol) type addressing. A special port (in the IP sense) is used. All data are decoded, data to be sent to the network are transmitted and data that are specific to the supervision dialogue are not. The connection unit must have the capacity to filter and transmit data within acceptable times.

Filtering may be done by the network by supervising narrow band communication and broadband communication on the same broadband line. Voice on xDSL (VoDSL) technologies offer a technique that could be reused for this purpose.

1. Method for managing the use of a telecommunication line (LT) and/or a terminal (T) connected to it without subscription or fixed fee from the user(s), characterised in that it comprises the following steps:
control use of the line for any access to a service in a spectral band of frequencies greater than 10 kHz, service operated on this line, this control comprising the following steps:
set up the said line (D, E) for each access request to a service in a spectral band of frequencies greater than 10 kHz (for example ADSL),
measure the occupancy time of this line for each of the said accesses,
cut off (D, E) the said line (LT) when each of the said accesses stops.

2. Method for managing the use of a line according to claim 1, characterised in that control of the use of the line (LT) is made on a frequency band separate from the frequency band for the service in a spectral band of frequencies greater than 10 kHz.

3. Method for managing the use of a line according to claim 1, characterised in that control of the use of the line (LT) is made on the same frequency band as the frequency band for the service in a spectral band of frequencies greater than 10 kHz.

4. Method for managing the use of a line according to any one of claims 1 to 3, characterised in that the line is set up and interrupted for service accesses within a spectral band of frequencies greater than 10 kHz of the said line (LT).

5. Method for managing the use of a line according to any one of the above claims, characterised in that the control includes control of payment for use of the line during an occupancy time measured during an access.

6. Method for managing the use of a line according to any one of the above claims, characterised in that the control includes a check of the charge.

7. Method for managing the use of a line according to any one of the above claims, characterised in that the control includes a check of the state of the terminal(s) (T) connected to the line (LT).

8. Method for managing the use of a line according to any one of the above claims, characterised in that the control includes downloading of application programs.

9. Method for managing the use of a line according to any one of the above claims, characterised in that it also comprises steps consisting of:
detecting frauds on the line;
interrupting the said line if a fraud is detected on the line.

10. Method for managing the use of at least one telecommunication line (LT) and/or at least one terminal (T) connected to it, characterised in that it comprises
means (E or UR) of controlling setting up and interrupting the connection capable of setting up the line following each request for access to a service in a spectral band with frequencies greater than 10 kHz (for example ADSL), and interrupting the line at each stoppage,
means of cutting off and setting up the line (D or UR),
means (D or UR) of measuring the occupancy time of the line during the said access.

11. Method for managing the use of at least one line according to claim 10, characterised in that the control means comprise means of checking operation of the private installation terminals.

12. Method for managing the use of at least one line according to claim 11, characterised in that it comprises means of connection with the private installation to which the telecommunication line and/or the terminal is assigned.

13. Method for managing the use of at least one line according to claim 12, characterised in that connection means between the control means and the terminal(s) include low throughput lines (STN or ISDN).

14. Management method according to claim 12, characterised in that the connecting means between the control means and the terminal(s) include high throughput lines (xDSL, for example ADSL).

15. Management method according to any one of claims 10 to 14, characterised in that it comprises a connection interface (D) between at least one service link in a spectral band of frequencies greater than 10 kHz and the public network.

16. Management method according to claim 14, characterised in that the interface (D) comprises means of cutting off and setting up the line and it is placed in the private installation.

17. Management method according to claim 16, characterised in that the interface (D) is placed in the public network and is controlled from the private installation.

18. Management method according to any one of claims 10 to 17, characterised in that the control means (UR) comprise means (CR) of cutting off and setting up the line and they are placed in the private installation.

19. Management method according to any one of claims 10 to 18, characterised in that it also comprises means of detecting a fraud on the line, and in that the means (E or UR) of checking that the connection has been set up and that the said connection has been cut off can also be used to cut off the said line in the case of a fraud detected by the fraud detection means.
Document WO-A-99-29065 describes a billing and management process for communications on a network. The process consists globally of differentiating billing for use of the network from billing for use of services. Use of the communication network is determined as a function of the data volume used, parameters for use of a telecommunication service are determined as a function of the service, and billing is debited from the subscriber's account.
